(19) United States
(12) Patent Application Publication
(10) Pub. No.: US 2009/0198542 A1
(43) Pub. Date: Aug. 6, 2009

(54) DISTRIBUTING PREMIUM CONTENT WITH ADVERTISING SPONSORSHIP

(76) Inventors: Tianyu L. D'AMORE, San Diego, CA (US); Giridhar D. MANDYAM, San Diego, CA (US); Mark G. STASKAUSKAS, San Diego, CA (US); Aram PEREZ, San Diego, CA (US)

Correspondence Address: QUALCOMM INCORPORATED, 5775 MOREHOUSE DR., SAN DIEGO, CA, 92121, US

(21) Appl. No.: 12/361,452

(22) Filed: Jan. 28, 2009

Related U.S. Application Data
(60) Provisional application No. 61/025,658, filed on Feb. 1, 2008.

(51) Int. Cl. G06Q 30/00; G06N 5/02; G06F 7/06; G06Q 10/00; G06F 17/30; H04L 9/32

(52) U.S. Cl. 705/7; 705/14; 706/47; 707/4; 707/9; 726/1; 707/E17.055; 707/E17.014

(57) ABSTRACT

Distribution of rights protected content as a function of advertisement based sponsorship is provided. Rights protected content can be obtained by a user for no cost or for a reduced cost in exchange for acceptance of advertisements. The advertisements can be provided as a condition that should be satisfied before the rights protected content is presented. The advertisement can be distributed as a single delivery or as a bundled delivery. The premium content and associated advertising rules can be shared between devices in a peer-to-peer manner.

### CROSS-REFERENCE

This application claims the benefit of U.S. Provisional Application Ser. No. 61/025,658, filed Feb. 1, 2008, entitled “DISTRIBUTING PREMIUM CONTENT WITH ADVERTISING SPONSORSHIP,” and assigned to the assignee hereof and the entirety of which is incorporated herein by reference.

### BACKGROUND

The following description relates generally to content distribution systems and more particularly to distribution of advertised sponsored content.

There are various digital applications and content sold in a digital market for a price that represents the value of the content. The end user (e.g., consumer) pays for the content value during the purchasing transaction. It is an accepted model that consumers will pay the full value of the purchase individually, and, the content is non-transferable. This model places a high acceptance threshold on the consumer. However, adoption has been slow and tends to hit a plateau after a certain point since most consumers will not infinitely purchase more new applications and content at a full premium price. However, the upfront investment on the content distribution system is difficult to recover.

Digital Rights Management (DRM) systems can charge end user consumers a premium price for content protected by digital rights. This renders the protection scheme complex since consumers might be motivated to circumvent the system to obtain the same content for a lower cost or at no cost. Generally, DRM systems utilize pricing and a rights object to lock the premium content. The consumer is not authorized to access the premium content until payment has been received and verified by the rights object. The monetary implication of the rights object can turn it into a target of theft and failure in DRM systems.

Some Content Management Systems (CMS) have implemented an advertising sponsored content model, however, there has not been cross-leveraging of the power of DRM, and, in such systems the content is free (e.g., not premium content). Additionally, there is no clearly established mapping between advertising and content value either for consumption or for advertising placement. Further, there is no assurance or tracking of how well the advertising was delivered and displayed to the end consumer. In addition, there is no clear reporting on what (how many times, how frequent, when, or even whether) advertising was displayed before content was accessed by the consumer.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with utilizing advertising in place of (or in addition to) a priced rights object. An aspect relates to a method performed by a communication device for distributing advertisement-sponsored content. The method includes transmitting a request for content and receiving advertisement rules associated with the content. The content can be associated with an access fee and the advertisement rules can define one or more conditions corresponding with presentation of an advertisement allowing access to the content in place of, or with a reduced access fee. The method also includes verifying conformance with the advertisement rules and selectively presenting the content based on the verification. In accordance with some aspects, the method includes metering data associated with fulfillment of the advertisement rules.

A further aspect relates to a communication apparatus that includes a memory and a processor. The memory retains instructions related to conveying a content request and accepting advertisement rules associated with the content. The memory can also retain instructions related to ascertaining conformance with at least one advertisement rule and presenting the content based on the conformance. The processor is coupled to the memory and is configured to execute the instructions retained in the memory.

Another aspect relates to a communication apparatus that includes means for conveying a request for content. The content is associated with an access fee. Apparatus also includes means for obtaining advertisement rules associated with the content. The advertisement rules define one or more conditions corresponding with presentation of an advertisement allowing access to the content in place of or with a reduced access fee. Also included in the apparatus are means for tracking actions associated with the one or more advertisements, means for reporting the actions, and means for presenting the content if the actions conform to the advertisement rules associated with the content.

A further aspect relates to presenting different levels of advertising packages associated with a given premium content item. Users can be given the opportunity to select a level of acceptance and usefulness of the advertising beyond selection of the content.

Yet another aspect relates to a computer program product that includes a computer-readable medium. The computer-readable medium includes a first set of instructions for causing a computer to transmit a request for content and a second set of instructions for causing the computer to receive advertisement rules associated with the content. The content is associated with an access fee. The advertisement rules define one or more conditions corresponding with presentation of an advertisement to allow access to the content in place of or with a reduced access fee. The computer-readable medium also includes a third set of instructions for causing the computer to verify conformance with the advertisement rules and a fourth set of instructions for causing the computer to selectively present the content based on the verification.

Still a further aspect relates to at least one processor configured for providing access to content. The processor includes a first module for transmitting a request for content and a second module for receiving advertisement rules associated with the content. The content is associated with an access fee. The advertisement rules define one or more conditions corresponding with presentation of an advertisement allowing access to the content in place of, or with a reduced access fee. The processor also includes a third module for verifying conformance with the advertisement rules and a fourth module for selectively presenting the content based on the verification.

In a related aspect is a method performed by a communication device for providing advertisement-sponsored content. The method includes generating a rights object that includes one or more parameters related to presentation (to a user) of an advertisement. The presentation (e.g., user viewing the content) is a key to unlocking the rights to the content.

Yet another aspect relates to a communication apparatus that includes a processor and a memory. The processor is coupled to the memory and is configured to execute the instructions retained in memory. The memory retains instructions related to creating a rights object that contains one or more parameters related to presentation of an advertisement. The presentation unlocks rights to the content.

Another aspect relates to a communications apparatus. The apparatus includes means for creating a rights object that includes one or more parameters related to an advertisement. Conformance with the one or more parameters can allow the rights protected content to be presented.

A further aspect relates to a computer program product that includes a computer-readable medium. The computer-readable medium includes at least one set of instructions for causing a computer to generate a rights object. The rights object contains rules associated with rendering one or more advertisements in conjunction with content. The advertisement unlocks rights for rendering the content.

Still a further aspect relates to at least one processor configured to provide advertisement-sponsored content. The processor includes at least one module for generating a rights object that includes one or more parameters related to a presentation of an advertisement. The presentation is a key to unlocking the rights to the content.

Another related aspect is a method performed by a communication device for sharing premium content with advertising sponsorship. The method includes receiving a request to share premium content with a peer device and determining the premium content is associated with one or more advertising rules. The method also includes communicating the premium content and the one or more advertising rules with the peer device.

Yet another aspect relates to a communication apparatus that includes a memory and a processor. The memory retains instructions related to receiving a request to share premium content with a peer device, determining the premium content is associated with one or more advertising rules, and communicating the premium content and the one or more advertising rules to the peer device. The processor is coupled to the memory and is configured to execute the instructions retained in the memory.

Still another aspect relates to a communication apparatus that includes means for receiving a request to share premium content with a peer device and means for determining the premium content is associated with one or more advertising rules. Also included in the apparatus is means for communicating the premium content and the one or more advertising rules with the peer device.

A further aspect relates to a computer program product comprising a computer-readable medium. The computer-readable medium includes a first set of instructions for causing a computer to receive a request to share premium content with a peer device and a second set of instructions for causing the computer to determine the premium content is associated with one or more advertising rules. Also included in the computer-readable medium is a third set of instructions for causing the computer to communicate the premium content and the one or more advertising rules with the peer device.

Still another aspect relates to at least one processor configured to provide advertisement-sponsored content. The processor includes a first module for receiving a request to share premium content with a peer device and a second module for determining the premium content is associated with one or more advertising rules. Also included in the processor is a third module for communicating the premium content and the one or more advertising rules with the peer device and a fourth module for retaining a copy of the premium content and the one or more advertising rules.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of the various aspects may be employed. Other advantages and novel features will become apparent from the following detailed description when considered in conjunction with the drawings and the disclosed aspects are intended to include all such aspects and their equivalents.

### BRIEF DESCRIPTION OF THE DRAWINGS

FIG. 1 illustrates an example system architecture that utilizes one or more of the disclosed aspects.

FIG. 2 illustrates a system that distributes advertisement-sponsored content, according to an aspect.

FIG. 3 illustrates a system that provides advertisement-sponsored content, in accordance with an aspect.

FIG. 4 illustrates an exemplary architecture for bundled delivery, in accordance with one or more aspects.

FIG. 5 illustrates an exemplary architecture for a separate delivery model, according to various aspects presented herein.

FIG. 6 illustrates a system for transferring content between peer devices, according to one aspect.

FIG. 7 illustrates a method for distributing advertisement-sponsored content, according to an aspect.

FIG. 8 illustrates a method for distributing advertisement-sponsored content according to one or more aspects disclosed herein.

FIG. 9 illustrates a method for providing advertisement-sponsored content, in accordance with an aspect.

FIG. 10 illustrates a method for facilitating peer-to-peer sharing of premium content, which can be accessed at a reduced access fee in accordance with one or more aspects.

FIG. 11 illustrates a system that facilitates distributing premium content with advertising sponsorship, in accordance with one or more of the disclosed aspects.

FIG. 12 illustrates an example system that distributes advertisement-sponsored content, in accordance with an aspect.

FIG. 13 illustrates an example system that provides advertisement-sponsored content, in accordance with an aspect.

FIG. 14 illustrates a system for sharing premium content with advertising sponsorship, according to an aspect.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing these aspects.

With the introduction of mobile and digital advertising, it can be desirable to subsidize the price of the content with advertising inserts. Therefore, the price of the content can be shared (at a percentage or in full) by the advertiser in exchange for creating a desired advertising effect to individual consumers on the consumers' mobile devices, which is a very private space to the consumer otherwise. Advertising without clear benefit to the consumer has a very low acceptance rate as a result. The disclosed aspects combine the advertising value directly into the content distribution system. Advertising can be distributed (either in a bundle or separately) as the “key” to unlock the content by interacting with a content agent resident on the mobile device to interact and control content launch, run times, usage model expiration, and even pause and resume behaviors. This can ensure that advertising can be inserted at different points of the application life cycle, such as at launch, during, and/or at the end, etc. The advertisement can also be inserted in various models that can provide further incentives for the user. For example, different advertising “points” can be earned based on whether the user views five shows (or the same show five times) versus viewing ten minutes of content. Depending on the value of the viewing (e.g., five shows, ten minutes, etc.), the user can earn points and can obtain a percentage off the premium cost of the application or content (e.g., reduced cost (or rebate) for purchasing the content, reduced price on a next purchase, and so forth). Thus, the one or more aspects described herein combine advertising value directly into a content distribution system.

As used in this application, the terms “component”, “module”, “system”, and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Furthermore, various aspects are described herein in connection with a mobile device. A mobile device can also be called, and may contain some or all of the functionality of a system, subscriber unit, subscriber station, mobile station, mobile, wireless terminal, node, device, remote station, remote terminal, access terminal, user terminal, terminal, wireless communication device, wireless communication apparatus, user agent, user device, or user equipment (UE). A mobile device can be a cellular telephone, a cordless telephone, a Session Initiation Protocol (SIP) phone, a smart phone, a wireless local loop (WLL) station, a personal digital assistant (PDA), a laptop, a handheld communication device, a handheld computing device, a satellite radio, a wireless modem card and/or another processing device for communicating over a wireless system. Moreover, various aspects are described herein in connection with a base station. A base station may be utilized for communicating with wireless terminal(s) and can also be called, and may contain some or all of the functionality of, an access point, node, Node B, e-NodeB, e-NB, or some other network entity.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

Additionally, in the subject description, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

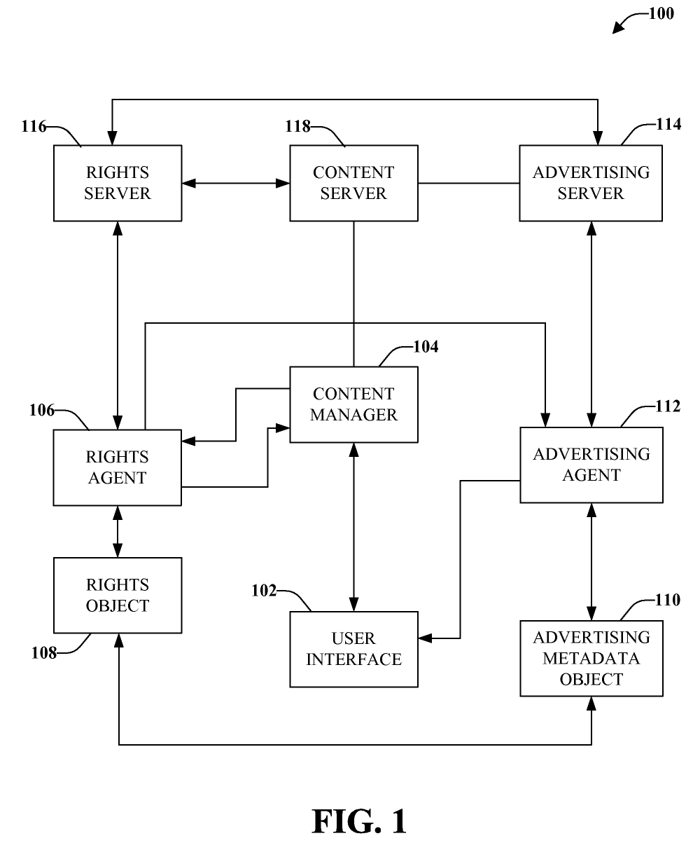

FIG. 1 illustrates an example system architecture 100 that utilizes one or more of the disclosed aspects. It should be noted that the illustrated system architecture 100 is an example and other variations can be utilized. In an aspect, the system architecture 100 can provide functionality to enable the user to receive ad-sponsored content. Additionally, in another aspect, the system architecture can provide those in the value chain (e.g., advertiser, content distributor, content owner, and so forth) additional revenue streams and increased distribution sales.

Included in system architecture 100 can be a user interface 102 through which a user can interact with system and/or request content. User interface 102 can interact with a content manager 104. For example, a request for a listing of content can be sent to the content manager 104. The listing of content can be retrieved by content manager 104 and presented to the user, through user interface 102, in various formats (e.g., audible, visually, and so forth).

The user can review the listing of content and request (e.g., through user interface 102) one or more content items from the listing. For example, the content listing can be displayed in a screen and the user can manually select an item in the listing (e.g., highlight and press “enter”). In accordance with some aspects, the request can be for various premium content and/or rights to protected content (e.g., content that is not distributed for “free,” etc.). Examples of premium content include, but are not limited to, gaming applications, business applications, music, ring tones, videos, or other applications that are usually provided to the user for a fee (e.g., copyrighted content, etc.), such as a royalty fee. It should be understood that throughout this detailed description various aspects are described with reference to a gaming application, however, the aspects are not limited to a gaming application and other applications can be utilized with the disclosed aspects.

The user can select the desired content (e.g., game, etc.) from a content listing (e.g., a list that is displayed visually on the screen, though a verbal command, and so forth). Based on the selection, content manager 104 communicates, with a rights agent 106 (or rights manager) to ascertain whether the content can be provided to the user (e.g., play the requested game). For example, the content manager 104 can transmit a rights request to the rights agent 106. The decision whether the content can be provided can be based on whether the user (through the associated device) has current and accurate (e.g., valid) rights.

Rights agent 106 can verify the rights that are contented in (or accessible by) a rights object 108. For example, rights object 108 can locate advertising based “rights” rules from an advertising metadata object 110. The advertising metadata object 110 can request advertising material from an advertising agent 112. Based on this request, advertising agent 112 can acquire advertising from an advertising server 114. Advertising server 114 can solicit information from a rights server 116. For example, rights server 116 and advertising server 114 can share information related to an embedded advertising metadata object (AMO) in a Rights Object. Further, advertising server 114 can receive inventory assignment information from a content server 118. Inventory assignment can relate to advertisements and the placement of the advertisements (e.g., upon product launch, after consumption of the content, and/or any point there between).

If there is inventory (e.g., one or more advertisements) assigned, advertising server 114 can convey an advertisement to the advertising agent 112. In accordance with some aspects, the advertisement is a targeted advertisement. According to some aspects, the advertisement is a general advertisement that is rendered (e.g., audio output though a speaker, visual output on a display, and so forth) to all users that consume the content. At substantially the same time as receiving the advertising, advertising agent 112 can cause the advertisements to be displayed (or rendered to the user in another format) on the user interface 102.

The rights object 108 can include a file or database, and can be configured to express what access rights are associated with the content (e.g., expiration, how long the content can be experienced, and so forth). Logic within the rights object 108 can include the conditions of the advertising (e.g., what advertisements should be presented to the user, whether the user should actively acknowledge the advertisements, the number, and/or type of advertisements, and so forth). At substantially the same time as content is being used (e.g., consumed), advertising can be displayed during the content expiration interval and/or at a more or less frequent pace, as enforced by the rights agent 106 and facilitated by the advertising agent 112. An advertising based rights object 108 can provide the advertiser the ability to attempt to reach consumers at the best possible time to create meaningful and valuable impressions and, at substantially the same time, attempt to make the advertising more useful and less intrusive for the user. The advertising based rights object 108 and/or an appropriate user interface 102 for content acquisition and download can provide the user with options to select the most desirable or acceptable advertising package to match a given piece of content.

If there are current and accurate rights, the rights agent 106 can retrieve the rights from the rights server 116 that is configured to distribute the rights. A rights assignment can be communicated with the content server 118. If the rights have been satisfied (e.g., the user has been presented with an advertisement, the user has acknowledged an advertisement, and so forth), the content acquisition is verified and the content acquisition approval is communicated to the content manager 104.

The rights agent 106 can approve the rights to unlock the content. At substantially the same time as an acknowledgement is received that the user has viewed or performed a function that satisfies the rights requirement (e.g., advertisement requirement), the content manager 104 is provided an indication to release the content (e.g., the gaming application). It should be noted that the advertisement delivery could be performed in parallel with the content delivery (e.g., advertisement is received at a device at substantially the same time as the content is received at the device). Thus, there can be a relationship between the rights agent 106 and advertising agent 112 and between the rights server 116 and the advertising server 114.

In accordance with some aspects, the rights are manually acknowledged by the user (e.g., when the user purchases the value of the premium content). In a similar manner, the advertising agent 112 and the advertising server 114 can acknowledge the advertising (e.g., tradeoff between lower cost and viewing an advertisement). In accordance with some aspects, the acknowledgement can be simply an advertisement that is displayed or presented to the user for a set interval or amount of time (e.g., five seconds) and the user does not have to manually (e.g., actively) acknowledge or perform any interaction with system 100 (e.g., the acknowledgement is that the set interval lapsed or expired). In accordance with other aspects, the acknowledgment can be a manual action or response by the user (e.g., explicit action), such as a clicking action (e.g., selecting an advertisement, acknowledging the advertisement by selecting “okay”) or other interactions with the advertisement.

The rights agent 106 can include logic that recognizes the content and/or that the “key” for unlocking the content is based on some digital rights and/or the advertising viewing rights. The rights agent 106 can determine the type of content, which can include being able to check with a database on the device to ascertain if the license is available.

In accordance with some aspects, the rights agent 106 (or rights manager) provides information to the advertising agent 112. This information can be referred to as metering and can include reporting and advertising rights events. For example, the metering can relate to how many times an advertisement was presented to a user, the behavior of the user after being presented the advertisement, the length of time the advertisement was presented to the user, and so forth. In accordance with some aspects, a token can be retained in a database to indicate that an advertisement has been viewed (e.g., metering). For example, if the user purchases a five-play game (e.g., game can only be played five times) the metering database can retain information as to the rights consumed (e.g., four of the games have been played). Likewise, if advertising is to be viewed a set number of times (e.g., six times), an incremental counter can be utilized so that each time the advertising is presented to the user the counter is incremented and recorded by metering database.

Additionally or alternatively, the metering information can be reported to a server (e.g., third party) to enable tracking of the effectiveness of the advertisements. Thus, the advertiser (though the third party) can have feedback relating to the users and that the users are actually being presented the advertisements. This can allow the advertiser to evaluate the effectiveness of the advertisement and determine if any changes should be made to improve the effectiveness of the advertising. In accordance with some aspects, the advertising can be targeted advertising. The advertisements may be one or more of graphical, audio, video, or haptic content.

In accordance with some aspects, the rights agent 106 and advertising agent 112 can be integrated. Both the rights agent 106 and advertising agent 112 can review similar criteria and make a determination if the license is a trigger (rights agent 106) or if the advertisements are a trigger (advertising agent 112) to access the content. However, having an independent rights agent 106 and an independent advertising agent 112 can provide modularity and that the determinations made by the respective agents do not influence each other.

In a related aspect, system 100 can be configured to display content from multiple sources and each of the sources can have its own advertising rights object. In these aspects, if one or more advertisements are disabled, system 100 can react accordingly, such as disabling the displaying application and, thus, the user has no rights to view any content. Alternatively, system 100 can disable only the content associated with the disabled advertisements. In this case, the user can still view content for which the advertising rights object is available or content that is not associated with advertisements.

It should be understood that other system architectures can be utilized other than the architecture illustrated and described with reference to FIG. 1. For example, content acquisition does not need to have a timed relationship with rights acquisition. The content acquisition and rights acquisition can occur independently, such as with advertising acquisition. Some system architectures can include, but are not limited to, system preparations of advertising rights object, as the key to unlock content; and client advertising agent to manage the acquisition of advertising material, metering, and rights event reporting.

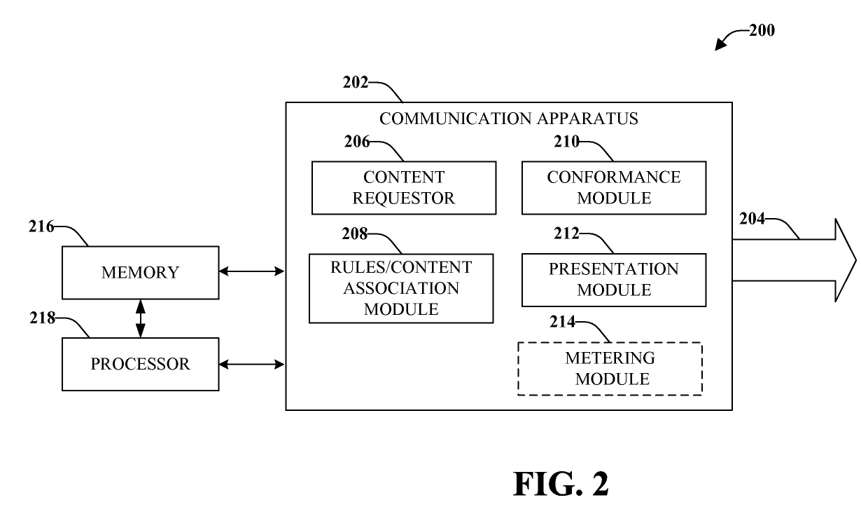

FIG. 2 illustrates a system 200 that distributes advertisement-sponsored content, according to an aspect. System 200 includes a communication apparatus 202 (e.g., wired or wireless) shown to be transmitting data through a channel 204. Although depicted as transmitting data, communication apparatus 202 can also receive data through the channel 204 (e.g., communication apparatus 202 can concurrently transmit and receive data, communication apparatus 202 can transmit and receive data at different times, or a combination thereof).

Communication apparatus 202 can include a content requestor 206 that is configured to request content. For example, content requester 206 can receive an indication from a user (e.g., through a user interface) for one or more content (e.g., application, video, song, and so forth). The content can be associated with an access fee (e.g., premium content). As a function of the user request, content requester 206 can transmit a request for the content from a content server, for example.

Based in part on the transmitted request, a rules/content association module 208 configured to receive one or more advertisement rules that are associated with the content. The one or more advertisement rules can be received at substantially the same time as the premium content is received. However, in accordance with some aspects, the one or more advertisement rules can be hard-coded into the device and the rules can be received from the internal source (where the hard-coded rules are located) at about the same time as the content is received. If the rules are hard-coded into the device, an indicator in the premium content can be utilized to specify when the rule(s) should be followed.

The advertisement rules can define one or more conditions that correspond with presentation of the advertisement. The user can receive the content at a reduced access fee as a function of satisfying the one or more conditions that correspond with the advertisement. For example, a condition can be that the user must explicitly acknowledge the advertisement (e.g., click on the advertisement, respond to a prompt, and the like). In another example, a condition can be that the advertisement is presented to the user and no user acknowledgement is needed (e.g., just presenting the advertisement satisfies the condition). As another example, advertisements can be periodically presented to the user while the user is utilizing the content. For example, while the user is watching a video, periodically advertisements can be presented to the user (e.g., similar to television advertisements).

In accordance with some aspects, a combination of conditions can be utilized in order to obtain a reduced access fee for various content. For example, the complexity of the conditions (e.g., explicitly acknowledging an advertisement, presentation of numerous advertisements, and so on) can be a function of the amount of reduction of the access fee. Thus, high complexity and/or a high number of conditions can result in a higher percentage fee reduction while low complexity and/or a limited number of conditions can result in a lower fee reduction.

Also included in communication apparatus 202 is a conformance module 210 that is configured to verify conformance with the advertisement rules. Verifying conformance includes confirming receipt of an acknowledgement from the user (e.g., an explicit acknowledgement), confirming the advertisement has been rendered (e.g., visual, audio, or other means of presentation) on the device. Other types of confirmation include verifying that a specific number of advertisements have been rendered, that one or more advertisements have been rendered a specified number of times, and so forth.

At substantially the same time as conformance of the advertisement rules has been verified, a presentation module 212 can present the content to the user. In accordance with some aspects, if conformance of the advertisement rules has been verified, presentation module 212 can present to the user information related to the discrepancy (e.g., “Please acknowledge that you have viewed the advertisement.”, “Please press okay to receive advertisement sponsorship in order to view the requested content”, and so forth). If the advertisement rules have not been verified, presentation module 214 can be configured to not present the content. If advertisement rules have been verified for some content, the content related to the conformance of the advertisement rules can be presented to the user, while content for which advertisement rules is not satisfied is not presented.

In accordance with some aspects, the advertisement rules can relate to allowing the user to perceive a subset of content after conformance with a rule. After consumption of that subset of content, conformance with another rule allows the user to perceive a second subset of content, and so forth. For example, the user might be presented with an advertisement and, after viewing that advertisement, the user can consume a portion of premium content (e.g., a movie) for a limited duration (e.g., ten or fifteen minutes). After that amount of time, a second advertisement is presented to the user. After viewing the second advertisement, the user can consume a next portion of premium content for a specified period (e.g., ten minutes), and so forth.

In accordance with some aspects, a metering module 214 is included in communication apparatus 202. Metering module 214 can be configured to gather metering data associated with fulfillment of the advertising rules. Additionally, metering module 214 can report information related to fulfillment of the advertising rules to an external source (e.g., an advertising agent). For example, if the user purchases a five-play game, metering module 214 can track and/or report information related to the number of times the user has played the game. Based on the number, advertising agent can selectively present an advertisement to the user (e.g., “You have used 4 of 5 games allowed, would you like information about a full feature game?”). In another example, there can be a single advertisement that is to be presented to the user a predetermined number of times. The metering module 214 can track the number of times the advertisement is presented to the user and/or report the information to an advertising agent. Other information related to fulfillment of the advertising rules can also be gathered and/or reported by metering module 214.

An advertising agent can utilize the information reported by metering module 214 to track the effectiveness of the advertisement. The reported information can also be utilized to determine the user behavior after viewing the advertisement. For example, at a later time it can be determine whether the user actually purchased the item, or whether the user appears to have ignored the ad, which can be determined by the user taking a longer time to explicitly acknowledge the advertisement (e.g., the user is not paying attention), and so forth. The metering functionality enabled by metering module 214 can allow the advertisement provider valuable information that can be utilized to increase the effectiveness of advertisements, provide targeted advertisements, as well as improving other marketing strategies.

System 200 can include memory 216 operatively coupled to communication apparatus 202. Memory 216 can be external to communication apparatus 202 or can reside within communication apparatus 202. Memory 216 can store information related to conveying a content request, accepting advertisement rules associated with the content, ascertaining conformance with at least one advertisement rule, and presenting the content based on the conformance. Memory 216 can also store other suitable information related to signals transmitted and received in a communication network. A processor 218 can be operatively connected to communication apparatus 202 (and/or memory 216) to facilitate analysis of information related to distributing premium content with advertising sponsorship in a communication network. Processor 218 can be a processor dedicated to analyzing and/or generating information received by communication apparatus 202, a processor that controls one or more components of system 200, and/or a processor that both analyzes and generates information received by communication apparatus 202 and controls one or more components of system 200.

Memory 216 can store protocols associated with distributing premium content with advertising sponsorship, taking action to control communication between communication apparatus 202 and other devices, such that system 200 can employ stored protocols and/or algorithms to enable the disclosed aspects as described herein. It should be appreciated that the data store (e.g., memories) components described herein can be either volatile memory or nonvolatile memory, or can include both volatile and nonvolatile memory. By way of example and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of example and not limitation, RAM is available in many forms such as synchronous RAM (DRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

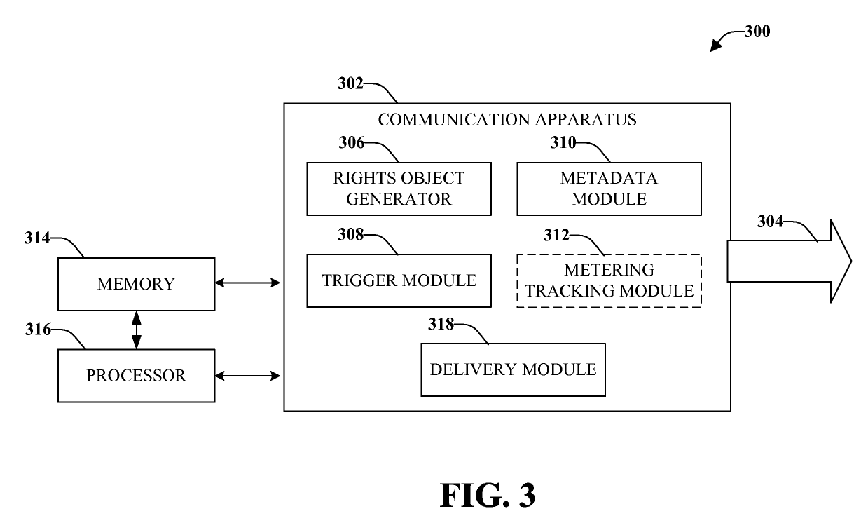

FIG. 3 illustrates a system 300 that provides advertisement-sponsored content, in accordance with an aspect. System 300 includes a communication apparatus 302 (e.g., wired or wireless), which can be, for example, an advertising agent, an advertising server, and the like. Although depicted as transmitting data through a channel 304, communication apparatus 302 can also receive data through the channel 304 (e.g., communication apparatus 302 can transmit and receive data at substantially the same time, communication apparatus 302 can transmit and receive data at different times, or combinations thereof).

Included in communication apparatus 302 is a rights object generator 306 that is configured to create a rights object. In accordance with some aspects, the rights object can include one or more parameters related to presentation of an advertisement. The presentation of the advertisement can be a key to unlocking the rights to the content. In accordance with some aspects, an explicit acknowledgement by a user (associated with a user device) to indicate that the advertisement has been received is utilized in conjunction with presentation of the advertisement in order to unlock the rights to the content.

According to various aspects, the rights object generator 306 can provide information related to the amount of time that the user has access to the content (e.g., the number of times viewed or played, duration in time, such as one week, one year, and so forth). Other information can be related to an expiration, such as a day/time that rights to the content expires. Other information can relate to whether a license, an advertisement, or both the license and the advertisement are a trigger (or key) for unlocking the content (e.g., allowing the user to receive the content).

Also included in communication apparatus 302 is a trigger module 308 that is configured to determine or recognize whether the key to the content is based on digital rights and/or based on advertisement viewing. For example, trigger module 308 can access (or receiving information from) a database to determine if there is a license (e.g., digital rights license) for the content. In accordance with some aspects, trigger module 308 utilizes information generated by the rights object generator 306 to make the determination.

Also included in communication apparatus 302 can be a metadata module 310 that is configured to deliver the rules as advertising metadata, which can be referred to as an advertising object. For example, the right object generator 306 indicates that in order to access an identified content, one or more advertisements need to be presented to the user, which can be a reference to an advertising object. The advertising object can provide information related to the metadata that provides parameters associated with the advertisement (e.g., advertising rules, etc.).

According to one or more aspects, the rights object is data that can be interpreted as the permissions applicable to the content and can include conditions under which to grant the permissions. In an aspect, the rights object can be a single file that is provided by communication apparatus 302. However, in accordance with other aspects, the rights object can exist in a binary format or a formalized format, such as XML or ASN.1, for example. In accordance with some aspects, the rights object is a few bits of data and/or instructions. Thus, depending on the implementation, the rights object can be provided by communication apparatus 302 in a variety of different formats.

In accordance with an aspect, the rights object provides an explicit rule or set of rules. However, in accordance with other aspects, the rights object provides an implicit rule or set of rules that can be hard coded into a device. In accordance with the aspect where the rule or set of rules are hard coded into the device, a rights object might not be provided with the content. However, in accordance with some aspects, a rights object is provided with the content and is utilized at substantially the same time as the implicit rule(s) hard coded into the device or in lieu of the implicit rule(s) hard coded into the device.

Communication apparatus 302 can also include a metering tracking module 312, which is optional as denoted by the dashed line. Metering tracking module 312 is configured to monitor whether or not the advertisement rules are being followed and, if the rules are being followed, to what degree the rules are being followed. The metering tracking module 312 can receive information from one or more mobile devices that track the information associated with conformance (or nonconformance) of the advertising rules. Additionally or alternatively, metering tracking module 312 can define the conformance/non-conformance information as categories of data (e.g., is the content usage based content, time based content, and so forth).

In accordance with some aspects, metering tracking module 312 can be configured to compile and present metering information to one or more advertising sponsors (e.g., the advertiser supplying the advertisement(s)). For example, the metering information can be complied based on parameters of interest to the advertising sponsor (e.g., demographics of the user). Information related to the user can be gathered based on a device identity, a user identity, or both the device identity and the user identity. Based on the information, an advertising supplier can modify an advertisement, modify how an advertisement is presented, tailor advertisements, and so forth.

System 300 can include memory 314 operatively coupled to communication apparatus 302. Memory 314 can be external to communication apparatus 302 or can reside within communication apparatus 302. Memory 314 can store information related to creating a rights object that contains one or more parameters related to presentation of an advertisement. Conformation with the rules can unlock the rights to the content. Memory 314 can also store other suitable information related to signals transmitted and received in a communication network. A processor 316 can be operatively connected to communication apparatus 302 (and/or memory 314) to facilitate analysis of information related to distributing premium content with advertising sponsorship in a communication network. Processor 316 can be a processor dedicated to analyzing and/or generating information received by communication apparatus 302, a processor that controls one or more components of system 300, and/or a processor that both analyzes and generates information received by communication apparatus 302 and controls one or more components of system 300.

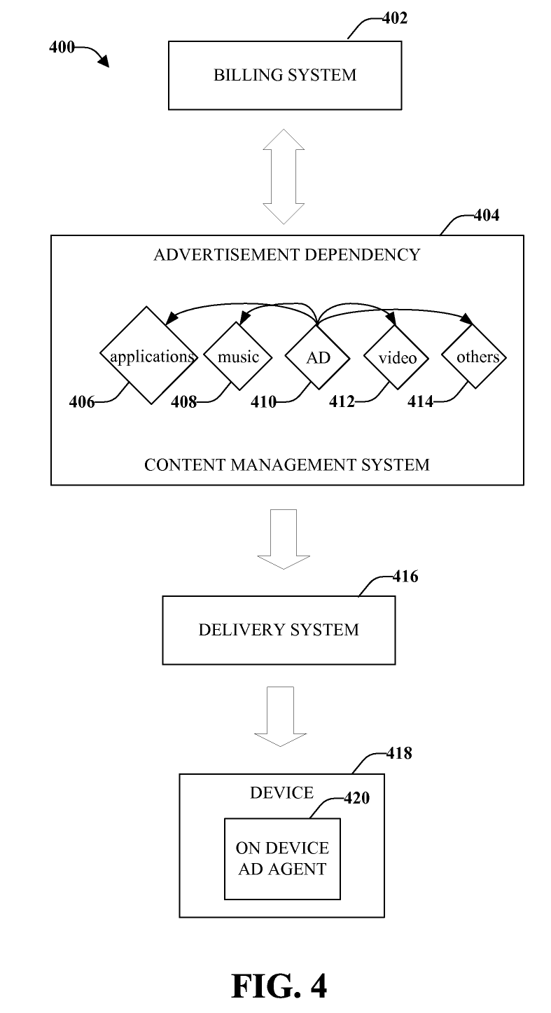

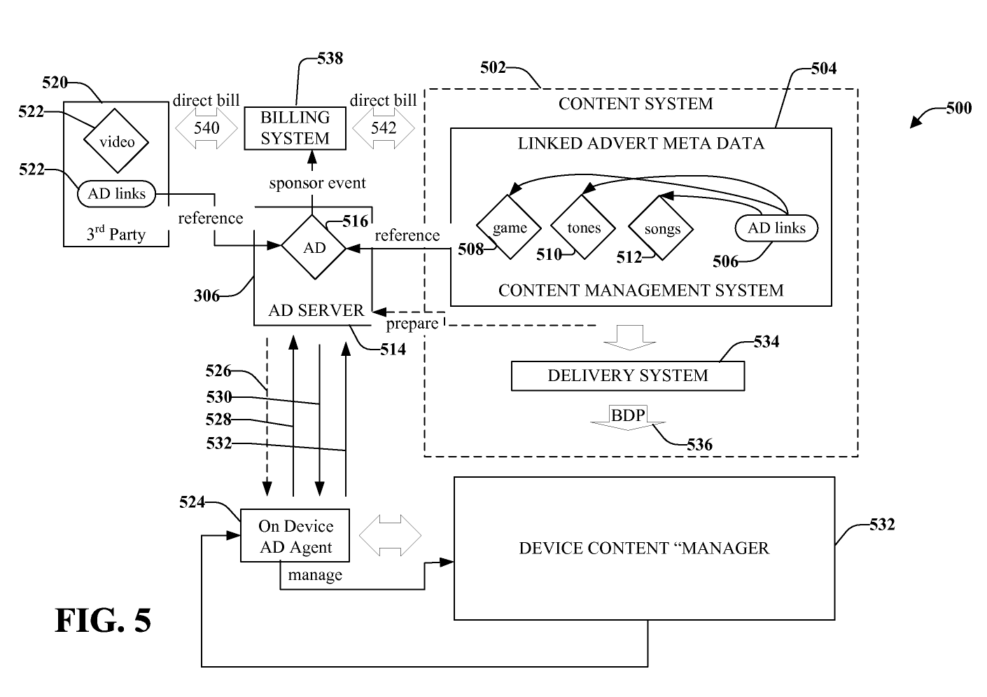

A delivery module 318 can be configured to deliver the advertisement and/or the content to a mobile device. In one aspect, there are at least two varieties of the main architecture concept (as illustrated in FIG. 1), categorized by how advertising is associated with content in the delivery process. One variety is the combined or bundled delivery and another is the separate delivery model. FIG. 4 illustrates an exemplary architecture for bundled delivery in accordance with one or more aspect and FIG. 5 illustrates an exemplary architecture for a separate delivery model according to various aspects presented herein.

With reference to FIG. 4, in bundled delivery 400, advertising material is ingested into a content system as another content item. The advertising material can potentially be earmarked as “advertising” through a piece of metadata as supported by the system 400. The valued premium content is marked (e.g., billing system 402) as associated with the advertising by another piece of metadata that describes a relationship between content items 404. Examples of content items 404 include applications 406, music 408, advertising (AD) 410, video 412, and others, represented at 414.

Associating the advertising by another piece of metadata that describes the relationship between content items 406-414, can help enable that advertising is packaged and delivered together with the content item (e.g., delivery system 416). The packaging process of the content item can include a set of metadata that describes the manner in which advertising material should be displayed. Examples of the manner in which advertising material should be displayed include, but are not limited to, once per launch, before application/content launch or render; every x minutes during the rendering of the content (video/audio); once every n launches; and so forth, wherein x and n are positive numbers.

The metadata operates as instructions for the device advertising agent as to when to lock, unlock, suspend, or resume content for advertising purposes. The manner selected can be suitable to the content or application being rendered, and can be negotiated through the content management system 404.

The package can be delivered to a device 418 in substantially the same manner as a normal content item. An on-device ad agent 420 can unpack the advertising (ad bundle), rules, and content. The content can be requested by the end user, triggering the agent to check the rules distributed with ad and content and unlock content only after the advertisment(s) has been presented according to the rules. The on device ad agent 420 can also respond to a content request, present advertising, unlock content for display/use and/or record, and report content/advertisement usage.

Referring now to FIG. 5, separate delivery 500 can be the model utilized when advertising material does not naturally reside in a bundled content system (or cannot be easily ingested due to volume or format fit and so on), or when the content distribution should be independent from the availability of the advertising material and vice versa. Separate delivery 500 can allow some flexibility in sharing of the premium content and creative distribution mechanisms. An agent can contain the intelligence to only unlock the content when the appropriate advertising has been obtained and presented (e.g., visually, audibly, or though other means). Thus, the advertising sponsorship can be fulfilled in creative ways.

A content system 502 can include a content management system 504 that is configured to link content to one or more advertisements, illustrated as AD links 506. The content can include, but are not limited to games 508, tones 510, songs 512, and so forth. The information (reference) associated with the advertisement links 506 is conveyed to an advertisement server 514 that associates an advertisement 516 with the content 508, 510, 512.

In accordance with some aspects, advertising material 516 corresponding to the content 508, 510, 512 can be acquired and new materials, such as different content, illustrated as video content 518, associated with a third party 520, can be updated to increase the value of the sponsorship. The new or different content 518 has an associated advertisement link 522 that is communicated to the advertising server 514. These aspects allow a set of acquisition communication to occur between an on-device advertising agent 524 and the advertising material warehouse, which in accordance with some aspects is the Content Management System (CMS) 504.

The advertisement server 514 can communicate a service trigger 526 to the on-device ad agent 524, which can respond with an ad request 528. In response to the ad request 528, advertisement service 514 can deliver an advertisement, at 530. At substantially the same time as receiving the advertisement (or at another time thereafter), the on device advertising agent 524 can respond with a delivery acknowledgement 532.

The on-device advertising agent 524 can manage a device content “manager” 532. The content and advertisement(s) can be delivered to the device though a delivery system 534. The content and advertisement (s) can be delivered to the device content manager 523 through a bundled delivery process 536, for example.

Some general information that can be exchanged to allow advertising to be efficiently obtained will now be provided. In a client pull model, the advertisement request 528 can specify device capabilities and parameters and/or specify content of the request. The device capabilities and parameters can include the device model, the device identification, the user identity, and other information. The device capabilities can include the software version, platform/operating system (OS) version, screen size, rendering capabilities, library versions, and so forth. Specifying the context of the request can include application/content ID, application/content description, application context (location or functional position of the “play” button, and so forth), as well as other relevant information.

The client pull module can also include the advertisement response/delivery. This can include delivery of the advertisement metadata, delivery of the advertisement content stream and/or the advertisement content targeted towards request parameters. The delivery of advertisement metadata can include display parameters, life time, reporting mechanisms, targeting content/applications, advertisement content type/size, advertisement content descriptions, and so forth. Delivery of the advertisement content stream can include the advertisement content and/or the “secret” to unlock premium content. The advertisement content targeted towards request parameters can include the device, subscriber, application function, and/or context.

In the server push model, there can be an advertisement service trigger. This trigger can be a messaging based trigger 526 (Wireless Application Protocol (WAP) push, Short Message Service (SMS), Multimedia Messaging Services (MMS), and so forth). In accordance with some aspects, there can be delivery of some advertising metadata based on server side analysis of match/fit with the device. In some aspects, the device can actively request specific advertising content based on the trigger. The “post trigger” flow is similar to the pull model.

In accordance with some aspects, a billing system 538 can directly bill 540, 542 advertisers associated with the content system 502 and/or the third party 520. For example, an advertisement can be a sponsored event (e.g., sponsored by a particular advertiser) and, based on this sponsored event, the associated advertiser is directly billed for the advertisement presentation.

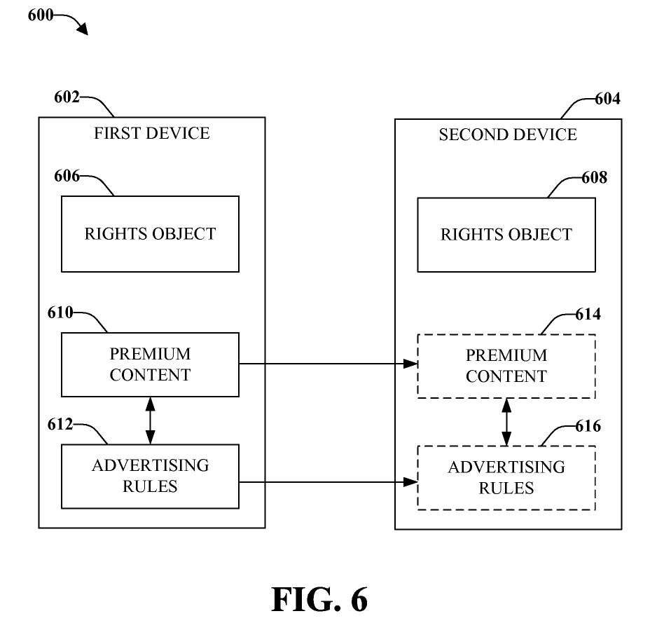

FIG. 6 illustrates a system 600 for transferring content between peer devices. System 600 includes a first device 602 and a second device 604, although any number of devices can be included in system. Each device 602, 604 includes respective rights object 606 and 608. The rights objects 606, 608 are configured to determine if various criteria are satisfied (e.g., advertising rules have been followed). If satisfied, the rights object 606, 608 releases the content (e.g., allows requested content to be presented to the user).

At times, users of devices 602 and 604 might desire to share content (e.g., share games, videos, and so forth). However, in accordance with the aspects disclosed herein, the content to be shared has associated advertising rules in order for the premium content to be provided to the user at a reduced access fee. System 600 is configured to transfer the advertising rules associated with that content when the content is shared between devices 602, 604.

For example, a first user, associated with the first device 602 has premium content 610 with associated rules 612. The first user can be authorized to share the premium content 610 with a second user, associated with second device 604. The first user instructs the rights object 606 to send the premium content 610 to the second device. Since the premium content 610 has associated advertising rules 612, both the premium content 610 and the advertising rules 612 are transferred to the second device 604.

After the transfer, second device 604 includes a copy of the premium content 614 and the advertising rules 616. When the second user desires to view the premium content 614, the rights object 608 determines whether (or not) there is compliance with the advertising rules 608. If the advertising rules 608 are complied with, the premium content 614 is presented to the second user. If the advertising rules are not complied with, the premium content 612 is not presented to the second user.

In such a manner, system 600 allows users to share premium content, which can be provided to the users at a reduced access fee, provided advertising rules associated with the premium content are satisfied for each user. Further, in accordance with some aspects, to share the premium content prior authorization is not needed, just the compliance with the advertising rules associated with the content. Thus, system 600 can allow peer to peer sharing of content, wherein the first user does not lose the premium content when it is transferred (or copied) to the second user (or more users).

Either of both devices 602, 604 can include memory and a processor. The memory can retains instructions related to receiving a request to share premium content with a peer device, determining the premium content is associated with one or more advertising rules, and communicating the premium content and the one or more advertising rules with the peer device. The processor can be coupled to the memory and can be configured to execute the instructions retained in the memory.

In view of the exemplary systems shown and described above, methodologies that may be implemented in accordance with the disclosed subject matter, will be better appreciated with reference to the following flow charts. While, for purposes of simplicity of explanation, the methodologies are shown and described as a series of blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement the methodologies described herein. It is to be appreciated that the functionality associated with the blocks may be implemented by software, hardware, a combination thereof or any other suitable means (e.g. device, system, process, component, etc.). Additionally, it should be further appreciated that the methodologies disclosed hereinafter and throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

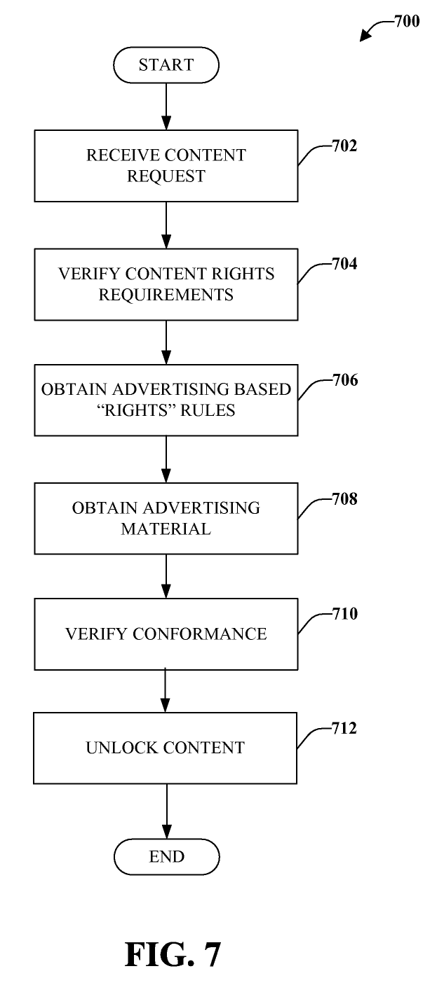

FIG. 7 illustrates a method 700 for distributing advertisement-sponsored content, according to an aspect. Method 700 starts, at 702, when a request for content is received. The content can be premium content (e.g. rights protected content) associated with a fee in exchange for access to the content. At 704, the content rights requirement is verified. This can include communicating with a rights agent and verifying the rights, such as by accessing a rights object. Advertising based “rights” rules can be obtained, at 706 from an advertising metadata object that can request the advertising material from an advertising agent. The advertising material can be acquired, at 708, such as from an advertising server. At 710, conformance with the rights is verified. If the rights are satisfied, the content is unlocked and the requested content can be presented to the user. If the rights are not satisfied, the content is not unlocked and the user is not granted access to the content.

In accordance with some aspects, content from multiple sources can be displayed and, if one or more advertisements are disabled, the content associated with the disabled advertisement is automatically disabled and the user no longer has the rights to view that content. Alternatively, the displaying application is disabled and the user no longer has rights to view any content, even content associated with advertisements that were not disabled, if any.

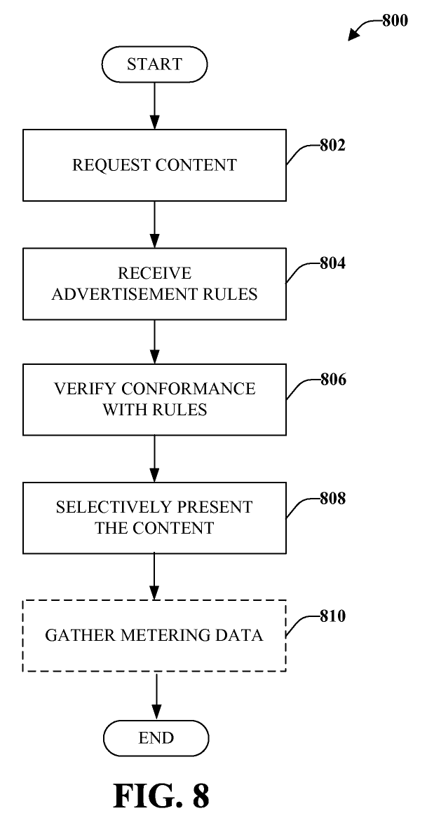

FIG. 8 illustrates a method 800 for distributing advertisement-sponsored content according to one or more aspects disclosed herein. An advertising model can replace or supplement a rights object with advertisements. In accordance with the various aspects, a typical attack towards a traditional DRM system of unauthorized content sharing becomes an authorized and beneficial activity for all parties of the ecosystem. This occurs since the advertising associated with the content (as well as the content itself) can be propagated to a wider audience than originally could be reached from a systematic distribution system. Thus, while a consumer is free from the burden of paying for additional “copies” of the digital content for such forwarding activities, advertising associated with the content can reach a wider audience based and a higher return on investment given consumers willing to participate in its distribution.

Method 800 starts, at 802, when a request for content is transmitted. The content can be associated with an access fee (e.g., premium content). At 804, advertisement rules associated with the content is received. The advertisement rules can be received from an external source (e.g., received at substantially the same time as the premium content is received) or from an internal source (e.g., hard-coded into a user device). The advertisement rules define one or more conditions corresponding with presentation of an advertisement allowing access to the content in place of or with a reduced access fee. At least one advertisement rule can be an explicit acknowledgement, which can include a user acknowledging the advertisement though a user interface. The advertisement can be a targeted advertisement. In accordance with some aspects, the advertisement can include graphical content, audio content, video content, haptic content, or combinations thereof.

At 806, conformance with the advertisement rules is verified. The content is selectively presented based on the verification. If conformance with the rules is verified, the content is presented to the user. If conformance with the rules is not verified, presentation of the content can be disabled (e.g., the user has no rights to view any content. In accordance with some aspects, if conformance with the rules is not verified, content associated with one or more advertisements rules for which conformance is not verified is disabled and content associated with one or more advertisement rules for which conformance is verified, if any, is enabled. According to some aspects, if conformance with the rules is not verified, content associated with one or more advertisements rules for which conformance is not verified is disabled and content that includes an available advertising rights object or content with no associated advertisement is enabled.

In accordance with some aspects, metering data associated with fulfillment of the advertisement rules can be gathered, at 808 (optional as denoted by the dashed box). The metering data can include a device identifier, a user identifier, or combinations thereof. Additionally or alternatively, the metering data includes reporting and advertising rights events. The metering data can be conveyed (e.g., communicated, transmitted) to an external source. In accordance with some aspects, the external source is an advertising agent.

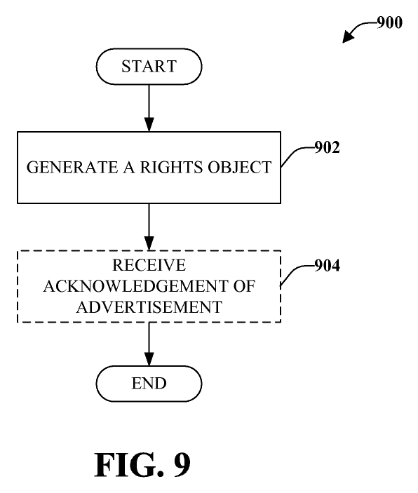

FIG. 9 illustrates a method 900 for providing advertisement-sponsored content, in accordance with an aspect. In accordance with the various aspects, advertising and premium content are combined in a symbiotic fashion. Advertising can be the key for unlocking the content. Users can benefit by obtaining content for a reduced cost if advertising is presented to the user in conjunction with the content and/or as a basis for receiving the content. Advertisers can benefit by the information received from a DRM system that confirms whether a user has viewed or experienced the advertisements in a specified amount of time and/or based on another scheme. According to some aspects, advertisers can receive a detailed aggregated report that includes the user activity with regard to viewing or experiencing advertisements. Content owners can receive payment in accordance with the report. Consumers can receive a discount (which at times can be significant) off the premium value of the content, thus, a more symbiotic overall ecosystem can be established.

At 902, a rights object that includes one or more parameters related to a presentation of an advertisement is generated. The presentation of the advertisement can be a key to unlocking the rights to the content. In accordance with some aspects, method 900 continues, at 904, where an explicit acknowledgment in response to the presentation of the advertisement is received. The presentation and the explicit acknowledgement are keys for unlocking the rights to the content (e.g., both the presentation and the acknowledgment are needed to unlock the content). In accordance with some aspects, the advertisement is provided in a bundled delivery. According to some aspects, the advertisement is provided in a separate delivery.

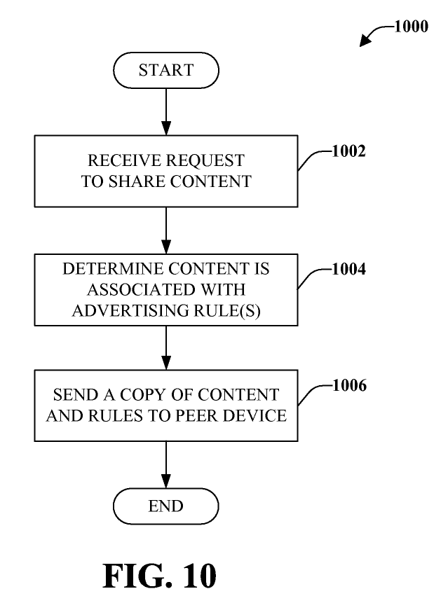

FIG. 10 illustrates a method 1000 for facilitating peer-to-peer sharing of premium content, which can be accessed at a reduced access fee in accordance with the aspects disclosed herein. The premium content can be shared without the device (that provided the content) losing the content (e.g., a copy of the content and advertising rules are maintained on the sharing device).

Method 1000 starts, at 1002, when a request to share content with another device is received. The request can be received from a user through a user interface, for example. The user can select another user to which the content should be sent by entering an identification of the other user (e.g., phone number, internet protocol address, and so forth) in the user interface. Other manners of identifying the other user can be selecting the user from a list, such as a buddy list. However, it should be understood that other means for selecting a peer device (e.g., other user) could be utilized.

At 1004, a determination is made that the premium content to be shared is associated with one or more advertising rules. These advertising rules allow the user to receive the premium content at a reduced fee (or for no fee). The amount or percentage off the retail price of the premium content can be a function of the number and/or complexity of the advertisements that are to be presented to the user in order to unlock the premium content.

If there are rules associated with the content, the rules and content are transferred to the peer device, at 1006. The content and rules that are transferred can be a copy of the original content, wherein the user sharing the content does not lose access to the original content. When the user of the peer device desires to use the premium content, the rules associated with the content must be satisfied in order for this second user to have access to the content, according to the various aspects presented herein.

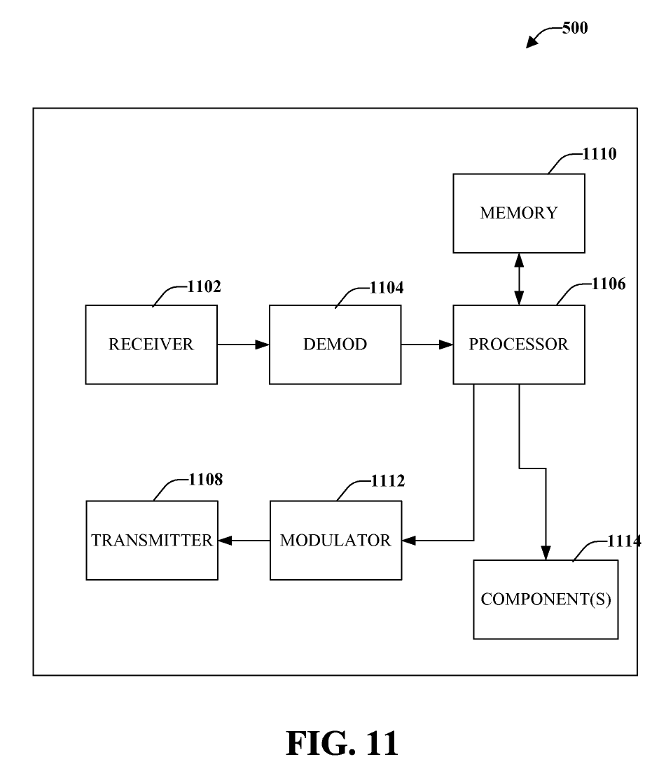

With reference now to FIG. 11, illustrated is a system 1100 that facilitates distributing premium content with advertising sponsorship in accordance with one or more of the disclosed aspects. System 1100 can reside in an access point and/or in a user device. System 1100 comprises a receiver 1102 that can receive a signal from, for example, a receiver antenna. The receiver 1102 can perform typical actions thereon, such as filtering, amplifying, downconverting, etc. the received signal. The receiver 1102 can also digitize the conditioned signal to obtain samples. A demodulator 1104 can obtain received symbols for each symbol period, as well as provide received symbols to a processor 1106.

Processor 1106 can be a processor dedicated to analyzing information received by receiver component 1102 and/or generating information for transmission by a transmitter 1108. In addition or alternatively, processor 1106 can control one or more components of device 1100, analyze information received by receiver 1102, generate information for transmission by transmitter 1108, and/or control one or more components of device 1100. Processor 1106 may include a controller component capable of coordinating communications with additional devices.

Device 1100 can additionally comprise memory 1110 operatively coupled to processor 1106 and that can store information related to coordinating communications and any other suitable information. Memory 1110 can additionally store protocols associated with coordinating communication. It will be appreciated that the data store (e.g., memories) components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory of the subject systems and/or methods is intended to comprise, without being limited to, these and any other suitable types of memory. Device 1100 can further comprise a symbol modulator 1112 and a transmitter 1108 that transmits the modulated signal.

Also included on device 1100 can be one or more additional components 1114 that can be configured to implement the various aspects disclosed herein. Such aspects include requesting content, displaying content, verifying conformance with one or more rights management systems, presenting advertisements in conjunction with and/or separately from premium content, as well as other actions.

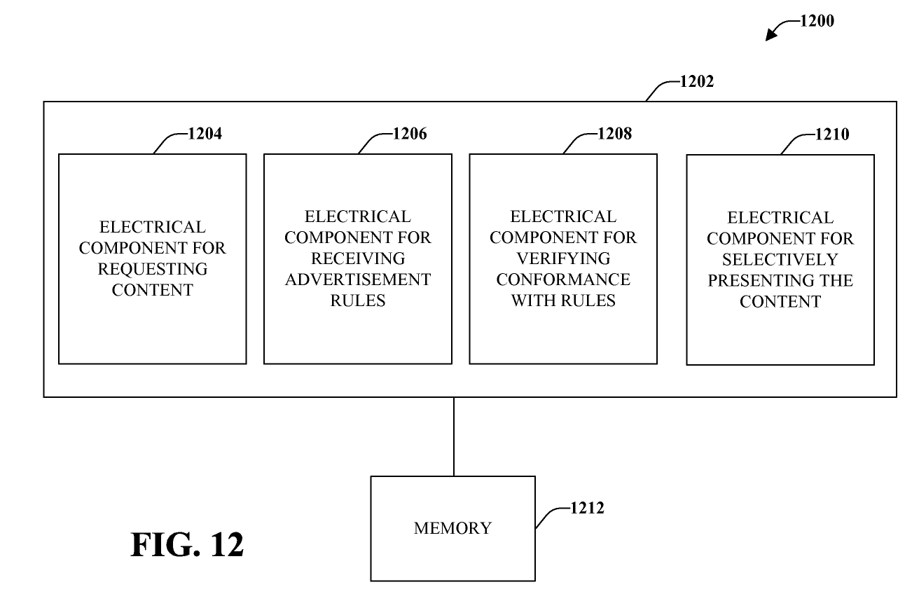

With reference to FIG. 12, illustrated is an example system 1200 that distributes advertisement-sponsored content, in accordance with an aspect. System 1200 can reside at least partially within a mobile device. It is to be appreciated that system 1000 is represented as including functional blocks, which may be functional blocks that represent functions implemented by a processor, software, or combination thereof (e.g., firmware).

System 1200 includes a logical grouping 1202 of electrical components that can act separately or in conjunction. Logical grouping 1202 includes an electrical component 1204 for transmitting a request for content. The content can be associated with an access fee (e.g., premium content). The request can be received from a user, such as through a user interface. Also included in logical grouping 1202 is an electrical component 1206 for receiving advertisement rules associated with the content. The advertisement rules can define one or more conditions corresponding with presentation of an advertisement and to allow access to the content in place of or with a reduced access fee. The advertisement can be a targeted advertisement or a general advertisement. According to some aspects, the advertisement includes graphical content, audio content, video content, haptic content, or combinations thereof.

Further, logical grouping 1202 includes an electrical component 1208 for verifying conformance with the advertisement rules. At least one advertisement rule can relate to receipt of an explicit acknowledgement. Also included is an electrical component 1210 for selectively presenting the content based on the verification.

In accordance with some aspects, logical grouping 1202 includes an electrical component for gathering data associated with fulfillment of the advertisement rules (e.g., metering data). The gathered data can include a device identifier, a user identifier, or combinations thereof. According to some aspects, the gathered data can include reporting and advertising rights events. Further, logical grouping 1202 can include an electrical component for conveying the gathered data to an external source. The external source can be an advertising agent.

Additionally or alternatively, logical grouping 1202 can include an electrical component for disabling presentation of the content if there is no verification of conformance with the advertisement rules. According to some aspects, logical grouping 1202 includes an electrical component for disabling content associated with one or more advertisement rules for which conformance is not verified and an electrical component for enabling content associated with one or more advertisement rules for which conformance is verified. In accordance with some aspects, logical grouping 1202 includes an electrical component for disabling content associated with one or more advertisements rules for which conformance is not verified and an electrical component for enabling content that includes an available advertising rights object or content with no associated advertisement.

Additionally, system 1200 can include a memory 1212 that retains instructions for executing functions associated with electrical components 1204, 1206, 1208, and 1210, or other components. While shown as being external to memory 1212, it is to be understood that one or more of electrical components 1204, 1206, 1208, and 1210 may exist within memory 1212.

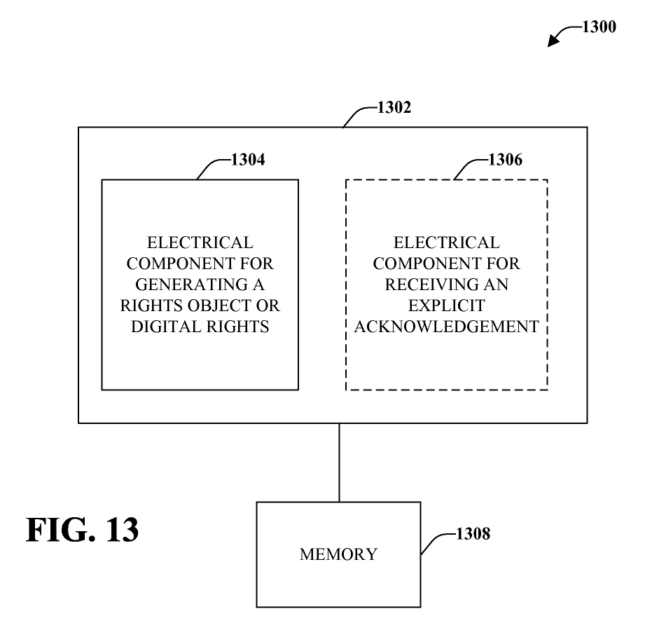

FIG. 13 illustrates an example system 1300 that provides advertisement-sponsored content, in accordance with an aspect. System 1300 is represented as including functional blocks, which may be functional blocks that represent functions implemented by a processor, software, or combination thereof (e.g., firmware). System 1300 includes a logical grouping 1302 of electrical components that can act separately or in conjunction.

Included in logical grouping 1302 is an electrical component 1304 for generating a rights object that includes one or more parameters related to a presentation of an advertisement. The presentation can be a key to unlocking the rights to the content. In accordance with some aspects, the presentation is a visual presentation, an audio presentation, or combinations thereof.

Additionally or alternatively, logical grouping 1302 includes an electrical component 1306 for receiving an explicit acknowledgment in response to the presentation of the advertisement, wherein the presentation and the explicit acknowledgement are the keys for unlocking the rights to the content. The advertisement can be provided in a bundled delivery or in a separate delivery.

System 1300 can include a memory 1308 that retains instructions for executing functions associated with electrical components 1304 and 1306 or other components. While shown as being external to memory 1308, it is to be understood that one or more of electrical components 1304 and 1306 may exist within memory 1308.

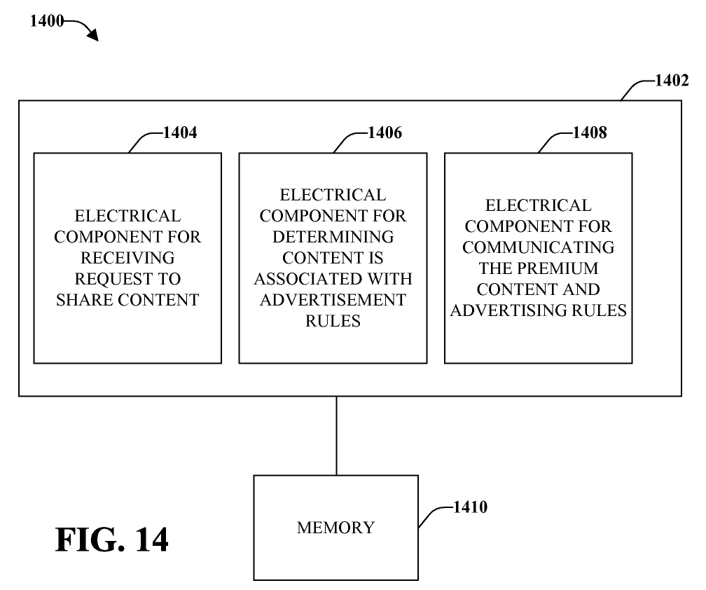

FIG. 14 illustrates a system 1400 for sharing premium content with advertising sponsorship, according to an aspect. System 1400 can be included in a user device and is represented as including functional blocks, which may be functional blocks that represent functions implemented by a processor, software, or combination thereof (e.g., firmware).

Included in system 1400 is a logical grouping 1402 of electrical components that can act separately or in conjunction. Included in logical grouping 1402 is an electrical component 1404 for receiving a request to share premium content with a peer device. The request can be received from a user and the content can be shared with a peer (e.g., friend, associate, co-worker, or any other person).

Also included in logical grouping 1402 is an electrical component 1406 for determining the premium content is associated with one or more advertising rules. The advertising rules associated with the premium content allow the content to be obtained (e.g., purchased) at a reduced access fee charge. Further, logical grouping 1402 includes an electrical component 1408 for communicating the premium content and the one or more advertising rules to the peer device.

In accordance with some aspects, logical grouping 1402 includes an electrical component for retaining a copy of the premium content and the one or more advertising rules. In such a manner, the user that requested to share the premium content still has access to the content (and associated advertising rules) in order to access the content.

It is to be understood that the aspects described herein may be implemented by hardware, software, firmware, or any combination thereof. When implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

For a software implementation, the techniques described herein may be implemented with modules (e.g., procedures, functions, and so on) that perform the functions described herein. The software codes may be stored in memory units and executed by processors. The memory unit may be implemented within the processor or external to the processor, in which case it can be communicatively coupled to the processor through various means as is known in the art. Further, at least one processor may include one or more modules operable to perform the functions described herein.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), CDMA2000, etc. UTRA includes Wideband-CDMA (W-CDMA) and other variants of CDMA. Further, CDMA2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE, and GSM are described in documents from an organization named “3rd Generation Partnership Project” (3GPP). Additionally, CDMA2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction, and/or data. Additionally, a computer program product may include a computer readable medium having one or more instructions or codes operable to cause a computer to perform the functions described herein.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

While the foregoing disclosure discusses illustrative aspects and/or aspects, it should be noted that various changes and modifications could be made herein without departing from the scope of the described aspects and/or aspects as defined by the appended claims. Accordingly, the described aspects are intended to embrace all such alterations, modifications, and variations that fall within scope of the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

To the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

What is claimed is:

1. A method performed by a communication device for distributing advertisement-sponsored content, comprising:
transmitting a request for content, wherein the content is associated with an access fee;
receiving advertisement rules associated with the content, wherein the advertisement rules define one or more conditions corresponding with presentation of an advertisement allowing access to the content in place of or with a reduced access fee;
verifying conformance with the advertisement rules; and
selectively presenting the content based on the verification.

2. The method of claim 1, further comprising metering data associated with fulfillment of the advertisement rules.

3. The method of claim 2, further comprising conveying the metering data to an external source.

4. The method of claim 3, wherein the external source is an advertising agent.

5. The method of claim 2, wherein the metering data comprises a device identifier, a user identifier, or combinations thereof.

6. The method of claim 2, wherein the metering data comprises reporting and advertising rights events.

7. The method of claim 1, wherein at least one advertisement rule is an explicit acknowledgement.

8. The method of claim 1, further comprising disabling presentation of the content if there is no verification of conformance with the advertisement rules.

9. The method of claim 1, further comprising:
disabling content associated with one or more advertisement rules for which conformance is not verified; and
enabling content associated with one or more advertisement rules for which conformance is verified.

10. The method of claim 1, further comprising:
disabling content associated with one or more advertisement rules for which conformance is not verified; and
enabling content that includes an available advertising rights object or content with no associated advertisement.

11. The method of claim 1, wherein the advertisement is a targeted advertisement.

12. The method of claim 1, wherein the advertisement comprises graphical content, audio content, video content, haptic content, or combinations thereof.

13. The method of claim 1, wherein the advertisement rules are hard-coded in the communication device.

14. A communications apparatus, comprising:
a memory that retains instructions related to conveying a content request, accepting advertisement rules associated with the content, ascertaining conformance with at least one advertisement rule, and presenting the content based on the conformance; and
a processor, coupled to the memory, configured to execute the instructions retained in the memory.

15. The communication apparatus of claim 14, wherein the memory further retains instructions related to metering data associated with fulfillment of the advertisement rules.

16. The communication apparatus of claim 15, wherein the memory further retains instructions related to conveying the metering data to an external source.

17. The communication apparatus of claim 15, wherein the metering data comprises a device identifier, a user identifier, or combinations thereof.

18. The communication apparatus of claim 15, wherein the metering data comprises reporting and advertising rights events.

19. The communication apparatus of claim 14, wherein at least one advertisement rule is an explicit acknowledgement.

20. The communication apparatus of claim 14, wherein the memory further retains instructions related to disabling presentation of the content if there is no verification of conformance with the advertisement rules.

21. The communication apparatus of claim 14, wherein the memory further retains instructions related to disabling content associated with one or more advertisement rules for which conformance is not verified and enabling content associated with one or more advertisement rules for which conformance is verified.

22. The communication apparatus of claim 14, wherein the memory further retains instructions related to disabling content associated with one or more advertisement rules for which conformance is not verified and enabling content that includes an available advertising rights object or content with no associated advertisement.

23. The communication apparatus of claim 14, wherein the advertisement is a targeted advertisement.

24. The communication apparatus of claim 14, wherein the advertisement comprises graphical content, audio content, video content, haptic content, or combinations thereof.

25. A communication apparatus, comprising means for conveying a request for content, wherein the content is associated with an access fee;
means for obtaining advertisement rules associated with the content, wherein the advertisement rules define one or more conditions corresponding with presentation of an advertisement allowing access to the content in place of or with a reduced access fee;
means for tracking actions associated with the one or more advertisements;
means for reporting the actions; and
means for presenting the content if the actions conform to the advertisement rules associated with the content.

26. The communication apparatus of claim 25, further comprising means for disabling presentation of the content if there is no verification of conformance with the advertisement rules.

27. The communication apparatus of claim 25, further comprising:
means for disabling content associated with one or more advertisement rules for which conformance is not verified; and
means for enabling content associated with one or more advertisement rules for which conformance is verified.

28. The communication apparatus of claim 25, further comprising:
means for disabling content associated with one or more advertisement rules for which conformance is not verified; and
means for enabling content that includes an available advertising rights object or content with no associated advertisement.

29. A computer program product, comprising:
a computer-readable medium, comprising:
a first set of instructions for causing a computer to transmit a request for content, wherein the content is associated with an access fee;
a second set of instructions for causing the computer to receive advertisement rules associated with the content, wherein the advertisement rules define one or more conditions corresponding with presentation of an advertisement allowing access to the content in place of or with a reduced access fee;
a third set of instructions for causing the computer to verify conformance with the advertisement rules; and
a fourth set of instructions for causing the computer to selectively present the content based on the verification.

30. At least one processor configured to provide access to content, comprising:
a first module for transmitting a request for content, wherein the content is associated with an access fee;
a second module for receiving advertisement rules associated with the content, wherein the advertisement rules define one or more conditions corresponding with presentation of an advertisement allowing access to the content in place of or with a reduced access fee;
a third module for verifying conformance with the advertisement rules; and
a fourth module for selectively presenting the content based on the verification.

31. A method performed by a communication device for providing advertisement-sponsored content, comprising
generating a rights object that includes one or more parameters related to a presentation of an advertisement, wherein the presentation is a key to unlock rights to content.

32. The method of claim 31, further comprising receiving an explicit acknowledgment in response to the presentation of the advertisement, wherein the presentation and the explicit acknowledgement are the keys to unlock the rights to the content.

33. The method of claim 31, wherein the advertisement is provided in a bundled delivery.

34. The method of claim 31, wherein the advertisement is provided in a separate delivery.

35. A communication apparatus, comprising:
a memory that retains instructions related to creating a rights object that contains one or more parameters related to presentation of an advertisement, wherein conformance with the rules unlocks rights to content; and
a processor, coupled to the memory, configured to execute the instructions retained in the memory.

36. The communication apparatus of claim 35, wherein the memory further retains instructions related to receiving an explicit acknowledgment in response to the presentation of the advertisement, wherein the presentation and the explicit acknowledgement are keys to unlock the rights to the content.

37. The communication apparatus of claim 35, wherein the advertisement is provided in a bundled delivery.

38. The communication apparatus of claim 35, wherein the advertisement is provided in a separate delivery.

39. A communications apparatus, comprising
means for creating a rights object that includes one or more parameters related to an advertisement, wherein conformance with the one or more parameters allows rights protected content to be presented.

40. The communication apparatus of claim 39, further comprising means for receiving an explicit acknowledgment in response to the presentation of the advertisement, wherein the presentation and the explicit acknowledgement are the keys for unlocking the rights to the content.

41. The communication apparatus of claim 39, wherein the advertisement is provided in a bundled delivery or a separate delivery.

42. A computer program product, comprising:
a computer-readable medium comprising at least one set of instructions for causing a computer to generate a rights object that contains rules associated with rendering one or more advertisements in conjunction with content, wherein the advertisement unlocks rights for rendering the content.

43. At least one processor configured to provide advertisement-sponsored content, comprising:
a first module for generating a rights object that includes one or more parameters related to a presentation of an advertisement, wherein the presentation is a key to unlock rights to content.

44. A method performed by a communication device for sharing premium content with advertising sponsorship, comprising:
receiving a request to share premium content with a peer device;
determining the premium content is associated with one or more advertising rules; and
communicating the premium content and the one or more advertising rules with the peer device.

45. The method of claim 44, further comprising retaining a copy of the premium content and the one or more advertising rules.

46. A communications apparatus, comprising:
a memory that retains instructions related to receiving a request to share premium content with a peer device, determining the premium content is associated with one or more advertising rules, and communicating the premium content and the one or more advertising rules to the peer device; and
a processor, coupled to the memory, configured to execute the instructions retained in the memory.

47. The communication apparatus of claim 46, wherein the memory further retains instructions related to retaining a copy of the premium content and the one or more advertising rules.

48. A communications apparatus, comprising:
means for receiving a request to share premium content with a peer device;
means for determining the premium content is associated with one or more advertising rules; and
means for communicating the premium content and the one or more advertising rules with the peer device.

49. A computer program product, comprising:
a computer-readable medium comprising:
a first set of instructions for causing a computer to receive a request to share premium content with a peer device;
a second set of instructions for causing the computer to determine the premium content is associated with one or more advertising rules; and
a third set of instructions for causing the computer to communicate the premium content and the one or more advertising rules with the peer device.

50. At least one processor configured to provide advertisement-sponsored content, comprising:
a first module for receiving a request to share premium content with a peer device;
a second module for determining the premium content is associated with one or more advertising rules;
a third module for communicating the premium content and the one or more advertising rules with the peer device; and
a fourth module for retaining a copy of the premium content and the one or more advertising rules.
